(19) United States
(12) Patent Application Publication
(10) Pub. No.: US 2009/0038127 A1
(43) Pub. Date: Feb. 12, 2009

(54) MESSAGE CLIP

(76) Inventor: David E. Farmer, Holland, MI (US)

Correspondence Address: FRASER CLEMENS MARTIN & MILLER LLC, 28366 KENSINGTON LANE, PERRYSBURG, OH, 43551, US

(21) Appl. No.: 12/187,523

(22) Filed: Aug. 7, 2008

Related U.S. Application Data
(60) Provisional application No. 60/954,335, filed on Aug. 7, 2007.

(51) Int. Cl. G09F 3/16; A44B 21/00

(52) U.S. Cl. 24/67 R

(57) ABSTRACT

An apparatus for displaying a message includes a body having a front surface and a rear surface with a flange extending about a periphery of the front surface forming a recessed area. A clip portion is connected to the rear surface for releasably holding the body on an item. A message portion having a display surface with a message displayed thereon is mounted on the body and received in the recessed area wherein the message is visible. The body can rotate relative to the clip portion or the message portion can rotate relative to the body to reorient the message for viewing.

### BACKGROUND OF THE INVENTION

The present invention relates generally to an apparatus for displaying a message and, in particular, to a clip with messaging for attachment to wearing apparel.

### SUMMARY OF THE INVENTION

A clip carrying a message is used to accessorize wearing apparel such as hats, clothes, book bags, bracelets, pants, etc. The clip gives people the opportunity to express themselves with a wide variety of messaging.

The message clip is formed from a body having a message portion attached to a front surface and a clip portion for attachment. The clip portion can be formed integral with the body, or can be a separate part attached to a rear surface of the body.

In a first embodiment, the message clip comprises: a body having a front surface and a rear surface with a flange extending about a periphery of the front surface forming a recessed area; a clip portion connected to the rear surface for releasably holding the body on an item; and a message portion having a display surface with a message displayed thereon, the message portion being mounted on the body and received in the recessed area wherein the message is visible.

In an alternate embodiment, the message clip comprises: a body having a front surface and a rear surface with a flange extending about a periphery of the front surface forming a recessed area; a clip portion rotatably connected to the rear surface for releasably holding the body on an item; and a message portion having a display surface with a message displayed thereon, the message portion being mounted on the body and received in the recessed area wherein the message is visible.

In another embodiment, the message clip comprises: a body having a front surface and a rear surface with a flange extending about a periphery of the front surface forming a recessed area; a clip portion connected to the rear surface for releasably holding the body on an item; and a message portion having a display surface with a message displayed thereon, the message portion being rotatably mounted on the body and received in the recessed area wherein the message is visible.

The message clip according to the present invention can be provided with a light and an audio player that are selectively actuated.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a front elevation view of a message clip in accordance with the present invention;

FIG. 2 is side view of the message clip shown in FIG. 1;

FIG. 3 is an enlarged partial cross-sectional view of an alternate embodiment the body and message portion of the message clip shown in FIGS. 1 and 2;

FIG. 4 is a partial side elevation view of another alternate embodiment of the body and the clip portion of the message clip shown in FIGS. 1 and 2;

FIG. 5 is an enlarged partial cross-sectional view of an alternate embodiment of the body and the clip portion of the message clip shown in FIGS. 1 and 2; and

FIG. 6 is a block diagram of a circuit for providing the message clip with light and sound according to the present invention.

### DESCRIPTION OF THE PREFERRED EMBODIMENT

The message clip according to the present invention is a distinctive product to accessorize hats, other articles of clothing, book bags, bracelets, etc. The unique design makes it easy to apply quickly to an assortment of things. The message clip gives people the opportunity to express themselves with a wide variety of messaging.

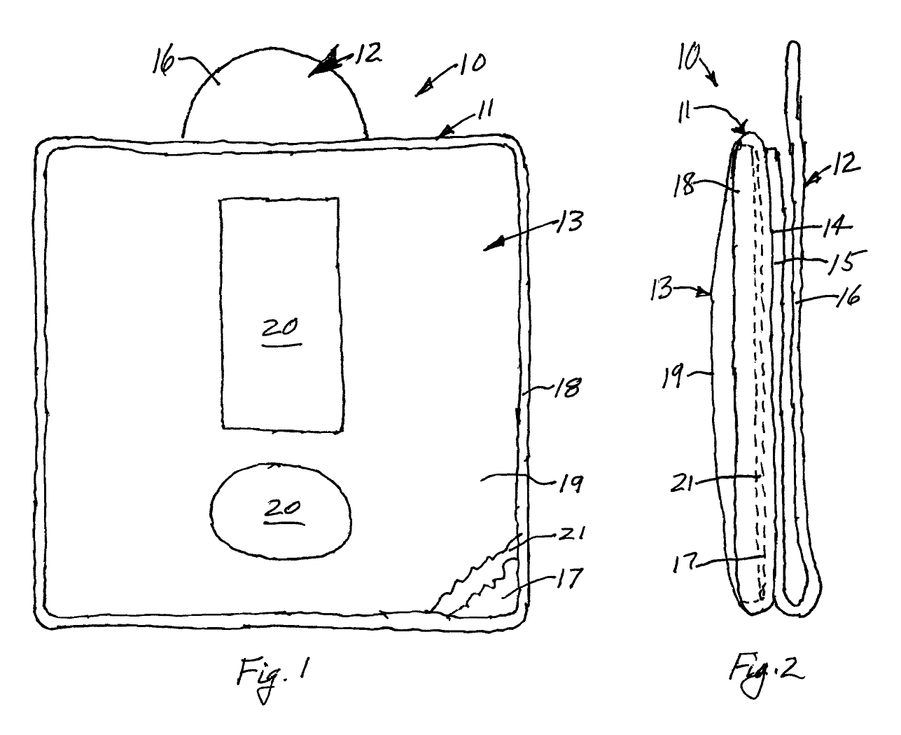

The message clip can be made of spring steel, plastic, precious metals, or other suitable material, in a shape similar to a basic money clip. As shown in FIGS. 1 and 2, a message clip 10 has a body 11 with a clip portion 12 attached to one side and a message portion 13 attached to an opposite side. The body 11 has a generally planar rear surface 14 to which the generally U-shaped clip portion 12 is attached at a generally straight leg 15 thereof. The clip portion 12 can be attached to the surface 14 by a fastening means in any suitable manner such as by welding or with an adhesive material. The clip portion 12 is formed from a resilient material so that a free leg 16 can be bent away from the attached leg 15 to insert an item therebetween such as one or more layers of cloth at an edge of a cap, shirt pocket, pants belt loop, etc. When released, the free leg 16 will spring back toward the attached leg 15 to firmly and releasably hold the message clip 10 on the item.

The body 11 has a front surface 17 at which the message portion 13 is mounted. The front surface 17 is surrounded at a periphery by an outwardly extending flange 18 to form a recessed area such that the message portion 13 is partially recessed (FIG. 2). An outwardly facing display surface 19 of the message portion 13 has a visible message applied thereto. As shown in FIG. 1, the message is an exclamation mark 20, but can be any symbol, logo, words, picture, etc. The display surface 19 can be flat or curved (as shown), and the message can be raised from and/or recessed into the surface 19. The message portion 13 can be attached to the front surface 17 by a fastening device 21 in any suitable manner such as by welding, or with an adhesive material, or by a mechanical fastener. For example, the fastening device 21 is shown in the form of a layer of adhesive material or a double-sided adhesive sheet. In a preferred embodiment, the body 11, the clip portion and the message portion are formed from etched brass and the message 20 is offset printed on the display surface.

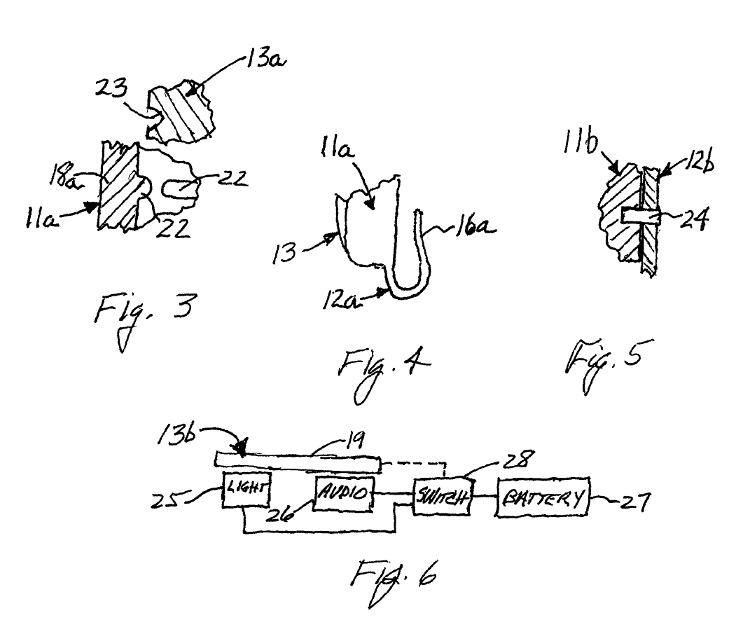

Other fastening devices can be used to attach the message portion to the body. As shown in FIG. 3, an alternate embodiment body 11a can have a projections 22 formed on an inner surface of a flange 18a. The projections 22 can be of any suitable shape and cooperate with a depression or groove 23 formed in a side of an alternate embodiment message portion 13a.

The message portion 13 can be permanently fixed relative to the clip portion 12, as well as be variably fixed, which allows the user to “turn” the display surface 19 to the desired angle. In some cases, the attachment of the message clip 10 to an item may require reorientation of the message 20 for proper viewing. For example, if the message clip 10 shown in FIG. 1 is rotated 90°, it may be difficult to recognize the message 20 as an exclamation mark. As shown in FIG. 5, an alternate embodiment body 11b can be attached to a clip potion 12b by a rotation device such as a pivot pin 24 that permits rotation of the body 11b relative to the clip portion 12b.

The message clip 10 also can be provided with the capability to light up and/or play sounds. As shown in FIG. 6, a light 25 and an audio player 26, for playing stored music, words, miscellaneous sounds, etc., are connected to a source of power such as a battery 27 by a switch 28. The light 25, the audio player 26, the battery 27 and the switch 28 can be located in the recess formed in the body 11 by the front surface 17 and the flange 18. A message portion 13b is used to selectively actuate the switch 28 by mechanical action, or preferably by sensing contact of a human finger on the display surface 19. Although only the one switch 28 is shown, separate switches could be provided for the light 25 and the audio player 26.

The message clip 10 can come in a variety of shapes and sizes to compliment the message 20 being displayed. For example, the body 11 and the message portion 13 can be circular. This would permit the message portion 13 to be rotatably attached to the body 11 by the pivot pin 24.

The message 20 can be proprietary and non-proprietary verbiage, slogans, sayings, taglines, company names, brand names, logos, icons, licensed materials, and imagery to express any messages desired.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An apparatus for displaying a message comprising:
a body having a front surface and a rear surface with a flange extending about a periphery of said front surface forming a recessed area;
a clip portion connected to said rear surface for releasably holding said body on an item; and
a message portion having a display surface with a message displayed thereon, said message portion being mounted on said body and received in said recessed area wherein said message is visible.

2. The apparatus according to claim 1 wherein said body has a round shape or square shape.

3. The apparatus according to claim 1 wherein said body is formed of at least one of a metal material and a plastic material.

4. The apparatus according to claim 1 wherein said clip portion is attached to said body.

5. The apparatus according to claim 4 wherein said clip portion is rotatably attached to said body.

6. The apparatus according to claim 4 wherein said clip portion is rotatably attached to said body by a pivot pin.

7. The apparatus according to claim 1 wherein said clip portion is formed integral with said body.

8. The apparatus according to claim 1 wherein said message portion is attached to said body by a fastening device.

9. The apparatus according to claim 8 wherein said fastening device is an adhesive material positioned between said message portion and said front surface of said body.

10. The apparatus according to claim 8 wherein said fastening device is at least one projection extending from said flange and at least one cooperating depression or groove formed in said message portion.

11. The apparatus according to claim 8 wherein said fastening device is a rotation device rotatably attaching said message portion to said body.

12. The apparatus according to claim 11 wherein said rotation device is a pivot pin.

13. The apparatus according to claim 1 including at least one of a light and an audio player positioned in said recessed area of said body.

14. The apparatus according to claim 13 wherein said at least one of a light and an audio player is connected to a power source by a switch positioned in said recessed area of said body.

15. The apparatus according to claim 14 wherein said switch is actuated by said message portion by one of movement and contact with said message portion.

16. An apparatus for displaying a message comprising:
a body having a front surface and a rear surface with a flange extending about a periphery of said front surface forming a recessed area;
a clip portion rotatably connected to said rear surface for releasably holding said body on an item; and
a message portion having a display surface with a message displayed thereon, said message portion being mounted on said body and received in said recessed area wherein said message is visible.

17. An apparatus for displaying a message comprising:
a body having a front surface and a rear surface with a flange extending about a periphery of said front surface forming a recessed area;
a clip portion connected to said rear surface for releasably holding said body on an item; and
a message portion having a display surface with a message displayed thereon, said message portion being rotatably mounted on said body and received in said recessed area wherein said message is visible.
